(19) United States
(12) Patent Application Publication
(10) Pub. No.: US 2026/0121254 A1
(43) Pub. Date: Apr. 30, 2026

(54) Secondary Battery

(71) Applicant: SK On Co., Ltd., Seoul (KR)

(72) Inventors: Seung Ho KWAK, Daejeon (KR); Soo Min PARK, Daejeon (KR); Jae Yun PARK, Daejeon (KR); Joo Hyuk LEE, Daejeon (KR); Myeong Shin CHO, Daejeon (KR); Dong Gu LEE, Gyeonggi-do (KR)

(21) Appl. No.: 19/363,788

(22) Filed: Oct. 21, 2025

(30) Foreign Application Priority Data
Oct. 25, 2024 (KR) 10-2024-0147724

(51) Int. Cl. H01M 50/538; H01M 10/04; H01M 50/107; H01M 50/536

(52) U.S. Cl. CPC H01M 50/538; H01M 10/0431; H01M 50/107; H01M 50/536

(57) ABSTRACT

Disclosed is a secondary battery. According to one aspect of the present disclosure, the secondary battery comprises an electrode assembly in which a first electrode, a second electrode, and a separator are wound, each of the first electrode and the second electrode comprises an active material-coated portion on which an active material is coated and an active material-uncoated portion on which the active material is not coated, and the active material-uncoated portion comprises a plurality of flaps arranged in a winding direction and bent, wherein the active material-uncoated portion is provided with a cutting line that cuts a part of a portion in which each flap is bent.

### CROSS-REFERENCE TO RELATED APPLICATION

The present application claims priority to and the benefit of Korean Patent Application No. 10-2024-0147724, filed on Oct. 25, 2024 in the Korean Intellectual Property Office, the entire disclosure of which is incorporated herein by reference.

### TECHNICAL FIELD

The present disclosure relates to a secondary battery.

### BACKGROUND

A secondary battery is one of the energy storage means that can be charged and discharged through electrochemical reactions. The secondary battery is used in various fields using electrical energy. For example, the secondary battery is widely used in the field of mobile devices such as mobile phones, notebooks, and tablets, and broader use is being explored in the field of transportation means such as vehicles, aircraft, and ships. In addition, demand for secondary batteries is increasing in the field of energy storage systems (ESSs) for utilizing surplus power.

Secondary batteries can be classified into pouch-types, prismatic-types, cylindrical-types, coin-types, and the like depending on their packaging form. Among them, cylindrical secondary batteries have the advantages of standardized sizes and ease of mass production, and thus recently, demand therefor in the field of vehicles and the like has been rapidly increasing. Meanwhile, some cylindrical secondary batteries employ a tabless structure in which a lead tab is omitted. The tabless structure can secure a larger current conduction area compared to a lead tab method, thereby effectively reducing resistance and heat generation.

### SUMMARY

Some embodiments of the present disclosure are directed to providing a secondary battery.

Some embodiments of the present disclosure are also directed to providing a secondary battery in which poor contact between an active material-uncoated portion of an electrode assembly and a current collector is prevented.

Some embodiments of the present disclosure are also directed to providing a secondary battery in which poor welding between an active material-uncoated portion of an electrode assembly and a current collector is prevented.

Some embodiments of the present disclosure are also directed to providing a secondary battery that can be widely applied to electric vehicles, battery charging stations, and other green technology fields such as solar power generation and wind power generation. In addition, some embodiments of the present disclosure may be used for eco-friendly electric vehicles (EVs) and hybrid vehicles to suppress air pollution and greenhouse gas emissions and prevent climate change.

According to an aspect of the present disclosure, there is provided a secondary battery comprising an electrode assembly in which a first electrode, a second electrode, and a separator are wound, each of the first electrode and the second electrode comprises an active material-coated portion on which an active material is coated and an active material-uncoated portion on which the active material is not coated, and the active material-uncoated portion comprises a plurality of flaps arranged in a winding direction and bent, wherein the active material-uncoated portion is provided with a cutting line that cuts a part of a portion in which each flap is bent.

In some embodiments, the active material-uncoated portion of the first electrode may be provided at an upper end of the first electrode and the active material-uncoated portion of the second electrode mat be provided at a lower end of the second electrode.

In some embodiments, the bent flap may form a welding surface to which a current collector is welded

In some embodiments, the cutting line may be provided parallel to the winding direction

In some embodiments, the cutting line may be provided at one end of a bent portion of each flap.

In some embodiments, the cutting line may be provided at both ends of a bent portion of each flap.

In some embodiments, each flap is provided by a dividing line that is spaced apart from each other in the winding direction and divides the active material-uncoated portion.

In some embodiments, the dividing line may be provided perpendicular to the winding direction.

In some embodiments, the dividing line may be provided inclined with respect to the winding direction.

In some embodiments, an angle at which the dividing line may be inclined with respect to the winding direction gradually increases or decreases in the winding direction.

In some embodiments, the cutting line may be connected to an inner end portion of the dividing line.

In some embodiments, the cutting line may extend from the inner end portion of the dividing line to one side in the winding direction.

In some embodiments, the cutting line may extend from the inner end portion of the dividing line to both sides in the winding direction.

In some embodiments, the secondary battery may comprise a case accommodating the electrode assembly, and the case may be provided in a cylindrical shape having a predetermined diameter and height.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a schematic side view of a secondary battery according to one embodiment of the present disclosure;

FIG. 2 is a schematic perspective view of an electrode assembly according to one embodiment of the present disclosure;

FIG. 3 is a schematic view illustrating a flap of the electrode assembly in FIG. 2 being bent;

FIG. 4 is a schematic cross-sectional view illustrating the flap of the electrode assembly in FIG. 2 in a bent state;

FIG. 5A is a view illustrating a cutting line of the flap according to one embodiment of the present disclosure;

FIG. 5B is a view illustrating a cutting line of a flap according to another embodiment of the present disclosure;

FIG. 6A is a view illustrating a cutting line and a dividing line of a flap according to one embodiment of the present disclosure;

FIG. 6B is a view illustrating a cutting line and a dividing line of a flap according to another embodiment of the present disclosure;

FIG. 6C is a view illustrating a cutting line and a dividing line of a flap according to still another embodiment of the present disclosure;

FIG. 7A is a view illustrating a cutting line and a dividing line of a flap according to yet another embodiment of the present disclosure; and

FIG. 7B is a view illustrating a cutting line and a dividing line of a flap according to yet another embodiment of the present disclosure.

### DETAILED DESCRIPTION OF EXEMPLARY EMBODIMENTS

Hereinafter, the present disclosure will be described in detail with reference to the accompanying drawings. However, this is merely exemplary, and the present disclosure is not limited to the exemplified specific embodiments.

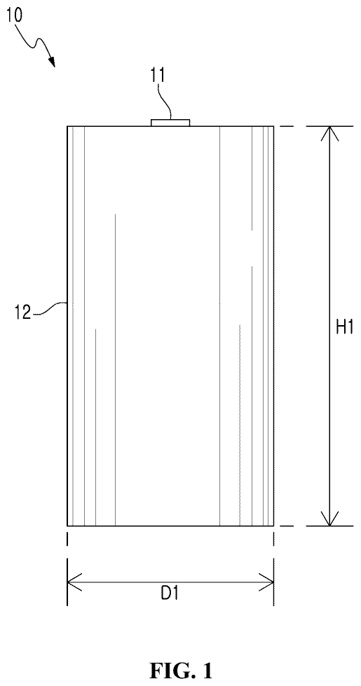

FIG. 1 is a schematic side view of a secondary battery according to one embodiment of the present disclosure. Referring to FIG. 1, in some embodiments, a secondary battery 10 may comprise a case 12. The case 12 may have an inner space in which an electrode assembly 100 is accommodated. The secondary battery 10 according to the present disclosure may comprise a terminal 11 constituting a positive electrode terminal, and the case 12 may constitute a negative electrode terminal.

In some embodiments, the case 12 may be provided in a cylindrical shape having a predetermined diameter D1 and height H1. For example, the secondary battery 10 may have a diameter of 46 mm and a height of 80 mm. In some cases, the secondary battery 10 having such a form factor may be referred to as a “4680 battery.” In another example, the secondary battery 10 may have a diameter of 46 mm and a height of 80 mm, a diameter of 46 mm and a height of 95 mm, or a diameter of 46 mm and a height of 110 mm. In some cases, the secondary battery 10 having such a form factor may be referred to as a “46xx battery.” In “46xx,” “xx” may indicate the height of the form factor. In another example, the secondary battery 10 may have a diameter of 48 mm and a height of 75 mm, a diameter of 48 mm and a height of 80 mm, or a diameter of 48 mm and a height of 110 mm. In some cases, the secondary battery 10 having such a form factor may be referred to as a “48xx battery.” In “48xx,” “xx” may indicate the height of the form factor. However, in the present disclosure, the diameter D1 and the height H1 of the secondary battery 10 may vary and are not necessarily limited to the above examples.

Meanwhile, in the present description, a cylindrical secondary battery 10 is illustrated, but the form factor of the secondary battery 10 according to the embodiments of the present disclosure is not necessarily limited to the illustrated cylindrical shape. The secondary battery 10 according to the embodiments of the present disclosure may be variously implemented or applied in the form of a coin-type, prismatic-type, pouch-type, or other non-standardized types within the scope of the technical spirit described below.

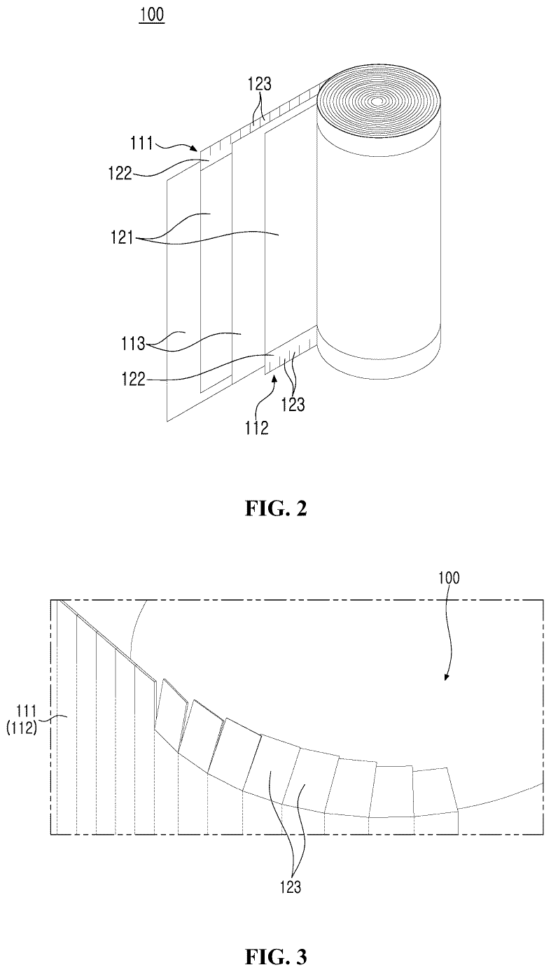

FIG. 2 is a schematic perspective view of an electrode assembly according to one embodiment of the present disclosure.

In some embodiments, the secondary battery 10 may comprise the electrode assembly 100 in which a first electrode 111, a second electrode 112, and a separator 113 are wound. The first electrode 111 and the second electrode 112 each comprise an active material-coated portion 121 on which an active material is coated and an active material-uncoated portion 122 on which the active material is not coated. The active material-uncoated portion 122 comprises a plurality of flaps 123 arranged in a winding direction and bent.

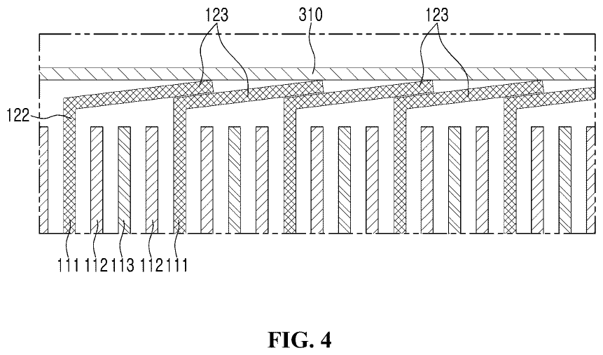

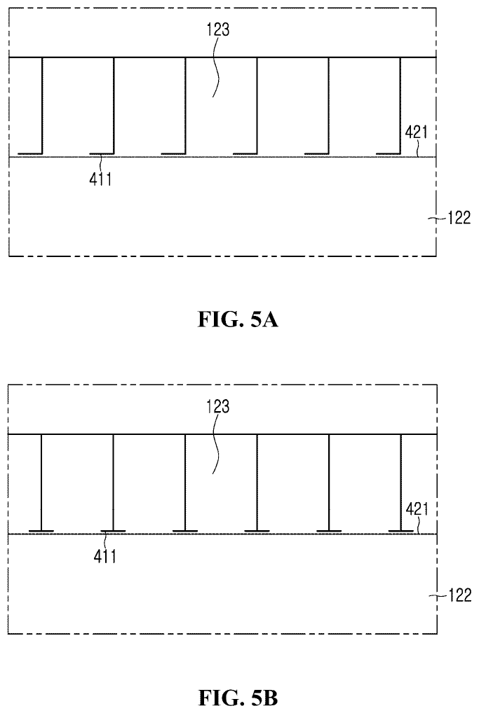

The first electrode 111 and the second electrode 112 may each comprise an active material-coated portion 121 on which an active material is coated and the active material-uncoated portion 122 on which the active material is not coated. The separator 113 may be provided between the first electrode 111 and the second electrode 112 (see FIG. 4). The active material-uncoated portion 122 may comprise the plurality of flaps 123 arranged in the winding direction. The winding direction is a direction in which the first electrode 111, the second electrode 112, and the separator 113 are wound around a central axis of the electrode assembly 100, which may be a circumferential direction of the electrode assembly 100 and a width direction of the flap 123 (left-right direction in FIGS. 5 to 10). The active material-uncoated portion 122 of the first electrode 111 and the active material-uncoated portion 122 of the second electrode 112 may be located in opposite directions.

In some embodiments, the active material-uncoated portion 122 of the first electrode 111 may be provided at an upper end of the first electrode 111, and the active material-uncoated portion 122 of the second electrode 112 may be provided at a lower end of the second electrode 112. That is, the active material-uncoated portion 122 of the first electrode 111 may be provided at the upper end the first electrode 111, but may not be provided at the lower end of the first electrode 111, and the remaining region of the first electrode 111 other than the active material-uncoated portion 122 may be the active material-coated portion 121. Similarly, the active material-uncoated portion 122 of the second electrode 112 may be provided at the lower end of the second electrode 112, but may not be provided at the upper end of the second electrode 112, and the remaining region of the second electrode 112 other than the active material-uncoated portion 122 may be the active material-coated portion 121.

FIG. 2 shows, for convenience of understanding and illustration, a state in which the first electrode 111, the second electrode 112, and the separator 113 are wound but the flap 123 is not bent, but the flap 123 may be bent simultaneously in a process in which the first electrode 111 and the second electrode 112 are wound together with the separator 113.

Meanwhile, the flap 123 may be arranged in the active material-uncoated portion 122 in the winding direction, but may not be provided in one end region of the active material-uncoated portion 122, which is a central portion of the electrode assembly 100. That is, in order to prevent a core of the electrode assembly 100 from being obscured by the bent flap 123, the flap 123 may not be provided in one end region of the active material-uncoated portion 122.

FIG. 3 is a schematic view illustrating a flap of the electrode assembly in FIG. 2 being bent.

FIG. 3 is a view for describing a structure in which the flap 123 is bent, and illustrates only some of the plurality of flaps 123. As illustrated in FIG. 3, the bending of the flap 123 may be performed in a process in which the first electrode 111, the second electrode 112, and the separator 113 are wound. The bending of the flap 123 may be continuously performed during the winding process, and the bent flap 123 may partially overlap the inner and outer flaps 123 (see FIG. 4), or may partially overlap the flaps 123 on both sides.

FIG. 4 is a schematic cross-sectional view illustrating the flap of the electrode assembly in FIG. 2 in a bent state.

Referring to FIG. 4, in some embodiments, the bent flap 123 may form a welding surface to which a current collector 310 is welded. That is, as the flap 123 is bent, the electrode assembly 100 may be provided with a welding surface for welding with the current collector 310. In a process in which the first electrode 111, the second electrode 112, and the separator 113 are wound, the flap 123 may be bent in a direction toward the center of the electrode assembly 100, and the welding surface may be provided. The flap 123 may be bent while partially overlapping each other in a radial direction of the electrode assembly 100. The current collector 310 may be welded to an upper surface or a lower surface of the electrode assembly 100 formed by the bent flap 123.

In addition, after the winding and bending are performed, a process of pressing and flattening the surface formed by the bent flap 123 for welding with the current collector 310 may be further performed. That is, although briefly illustrated in the drawing for convenience of illustration and understanding, the bent flap 123 may undergo a flattening process to form a flat welding surface. The current collector may be welded to the bent flap 123, and the current collector 310 may be electrically connected to the terminal 11 or the case 12 so that a positive electrode terminal and a negative electrode terminal of the secondary battery 10 according to the present disclosure may be formed.

Since the flap 123 has a predetermined width in the winding direction, a lifting phenomenon of a base end portion may occur when winding and bending are performed (see FIG. 3). Although a bent portion of the flap 123 has a linear shape for bending, the electrode is wound in a curved shape, and thus the base end portion of the flap 123 is difficult to be completely adhered. When the lifting phenomenon of the base end portion of the bent flap 123 occurs, even when a flattening process is performed, it is difficult to uniformly secure a welding surface with the current collector 310 formed by the bent flap 123, which makes it difficult to maintain consistent contact between the electrode assembly 100 and the current collector 310.

In addition, when a contact surface between the electrode assembly 100 and the current collector 310 is not uniformly secured, welding heat may be concentrated in a partial region during welding, which may cause the current collector 310 to be locally melted or welding spatter to occur, thereby leading to poor welding.

In addition, when the base end portion of the flap 123 is lifted and protrudes outward, contact with an inner surface of the case 12 may occur in a process of inserting the electrode assembly 100 into the case 12, which may cause the case 12 to be damaged or a short circuit to occur.

FIG. 5A is a view illustrating a cutting line of the flap according to one embodiment of the present disclosure.

Referring to FIG. 5A, in some embodiments, the active material-uncoated portion 122 may be provided with a cutting line 411 that cuts a part of a portion in which each flap 123 is bent. In the secondary battery 10 according to the present disclosure, by providing the active material-uncoated portion 122 with the cutting line 411, the lifting phenomenon of the base end portion of the bent flap 123 may be prevented.

The active material-uncoated portion 122 may be provided with the cutting line 411 that cuts a part of the portion in which each flap 123 is bent. The flap 123 is bent along a predetermined line 421, and by cutting a part of a portion in which the flap 123 is bent with the cutting line 411, the lifting phenomenon of the base end portion of the flap 123 may be prevented. By partially cutting the bent portion of the flap 123 with the cutting line 411, the base end portion of the flap 123 may be bent along a line as close as possible to a straight line, thereby preventing lifting.

In some embodiments, the cutting line 411 may be provided parallel to the winding direction. That is, the part of the portion in which each flap 123 is bent may be cut parallel to the winding direction by the cutting line 411.

In some embodiments, the cutting line 411 may be provided at one end of the bent portion of each flap 123. In the drawings, an embodiment is illustrated in which the cutting line 411 is provided and cut at a right end portion of the bent portion of each flap 123. By cutting one end portion of the bent portion of each flap 123 with the cutting line 411, the lifting phenomenon of the base end portion of the bent flap 123 may be suppressed. A length cut by the cutting line 411 provided at one end portion may be less than or equal to ½ of a width of each flap 123. Alternatively, the length cut by the cutting line 411 formed at one end portion may be less than or equal to ⅓ of the width of each flap 123.

FIG. 5B is a view illustrating a cutting line of a flap according to another embodiment of the present disclosure.

Referring to FIG. 5B, in some embodiments, a cutting line 411 may be provided at both ends of a bent portion of each flap 123. By cutting both end portions of the bent portion of each flap 123 with the cutting line 411, a lifting phenomenon of a base end portion of the bent flap 123 may be suppressed. Both end portions of the bent portion of each flap 123 may be cut to the same length. Alternatively, one end portion of the bent portion of each flap 123 may be cut longer or shorter than the other end portion. In the drawings, an embodiment is illustrated in which both end portions of the bent portion of each flap 123 are cut to the same length. A total length cut by the cutting line 411 formed at both end portions may be less than or equal to ½ of the width of each flap 123. Alternatively, the total length cut by the cutting line 411 formed at both end portions may be less than or equal to ⅓ of the width of each flap 123.

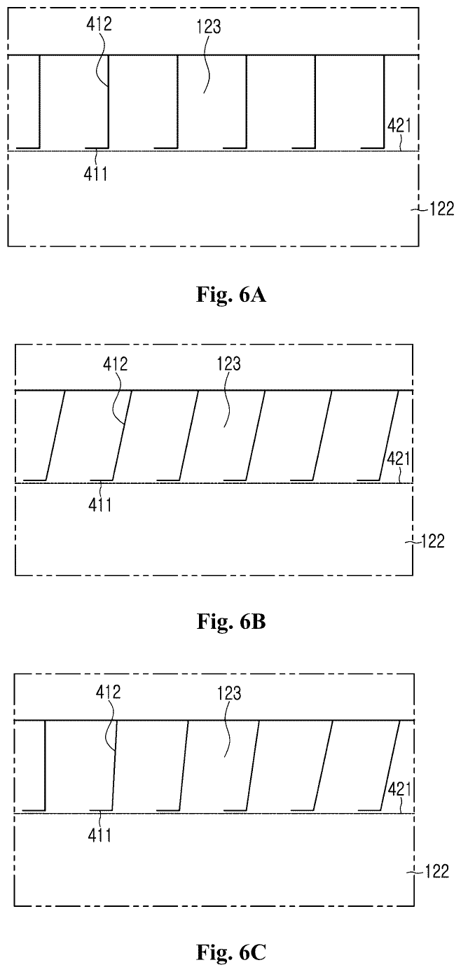

FIG. 6A is a view illustrating the cutting line and a dividing line of a flap according to one embodiment of the present disclosure, FIG. 6B is a view illustrating a cutting line and a dividing line of a flap according to another embodiment of the present disclosure, and FIG. 6C is a view illustrating a cutting line and a dividing line of a flap according to still another embodiment of the present disclosure.

Referring to FIG. 6A, in some embodiments, each flap 123 is provided by a dividing line 412 that is spaced apart from each other in the winding direction and divides the active material-uncoated portion 122. That is, an upper end or a lower end of the active material-uncoated portion 122 may be divided by the dividing line 412 spaced apart in the winding direction, and the flap 123 may be provided between the dividing lines 412.

As illustrated in FIG. 6A, in some embodiments, the dividing line 412 may be provided perpendicular to the winding direction. Alternatively, as illustrated in FIG. 6B, in some embodiments, the dividing line 412 may be provided inclined with respect to the winding direction. In some embodiments, an angle at which the dividing line 412 is inclined with respect to the winding direction may be 30 degrees or less. Alternatively, in some embodiments, an angle at which the dividing line 412 is inclined with respect to the winding direction may be 45 degrees or less. Alternatively, in some embodiments, the angle at which the dividing line 412 is inclined with respect to the winding direction may be 60 degrees or less.

In some embodiments, the angles at which the respective dividing lines 412 are inclined with respect to the winding direction may be the same. Alternatively, in some embodiments, the angles at which the respective dividing lines 412 are inclined with respect to the winding direction may not be constant.

Referring to FIG. 6C, in some embodiments, an angle at which each dividing line 412 is inclined with respect to the winding direction may gradually increase or decrease in a direction from one end of the active material-uncoated portion 122, which is a central portion of the electrode assembly 100, to the other end of the active material-uncoated portion 122. In the drawing, an embodiment is illustrated in which the angle at which the dividing line 412 is inclined with respect to the winding direction increases from left to right. Conversely, the angle at which the dividing line 412 is inclined with respect to the winding direction may decrease from left to right in the drawing.

Meanwhile, in some embodiments, the cutting line 411 may be connected to an inner end portion of the dividing line 412. The dividing line 412 may extend inward from an upper end (or a lower end) of the active material-uncoated portion 122 in a direction perpendicular or inclined with respect to the winding direction, and the cutting line 411 may be connected to the inner end portion of the dividing line 412. That is, the cutting line 411 and the dividing line 412 may be integrally provided. The connected cutting line 411 and dividing line 412 may be arranged in the winding direction, and each connected cutting line 411 and dividing line 412 may be simultaneously provided in one process. That is, a process of dividing the active material-uncoated portion 122 along the dividing line to form the flap 123 and a process of cutting the bent portion of the flap 123 to prevent lifting of the base end portion may be simultaneously and continuously performed in the winding direction.

Referring again to FIGS. 6A and 6B, in some embodiments, the cutting line 411 may extend to one side in the winding direction from the inner end portion of the dividing line 412. In the drawings, an embodiment is illustrated in which the cutting line 411 extends to the left from the inner end portion of the dividing line 412. The cutting line 411 extending to one side in the winding direction from the inner end portion of the dividing line 412 cuts one end portion of the bent portion of the flap 123.

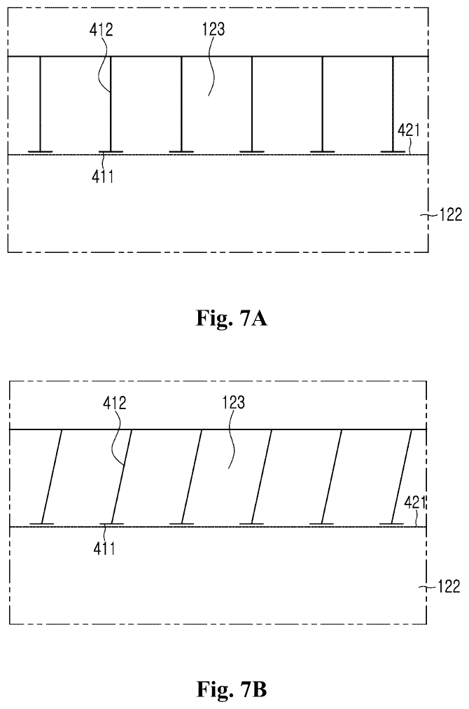

FIG. 7A is a view illustrating a cutting line and a dividing line of a flap according to yet another embodiment of the present disclosure, and FIG. 7B is a view illustrating a cutting line and a dividing line of a flap according to yet another embodiment of the present disclosure.

Referring to FIG. 7A, in some embodiments, a cutting line 411 may extend to both sides in the winding direction from an inner end portion of a dividing line 412. The cutting line 411 extending to both sides in the winding direction from the inner end portion of the dividing line 412 cuts end portions of adjacent flaps 123, and thus both end portions of a bent portion of each flap 123 may be cut. Referring to FIG. 7B, in some embodiments, a dividing line 412 may be provided inclined with respect to the winding direction. In some embodiments, an angle at which the dividing line 412 is inclined with respect to the winding direction may be 30 degrees or less. Alternatively, in some embodiments, the angle at which the dividing line 412 is inclined with respect to the winding direction may be 45 degrees or less. Alternatively, in some embodiments, the angle at which the dividing line 412 is inclined with respect to the winding direction may be 60 degrees or less. Alternatively, in some embodiments, the angle at which each dividing line 412 is inclined with respect to the winding direction may gradually increase or decrease in a direction from one end of the active material-uncoated portion 122, which is a central portion of the electrode assembly 100, to the other end of the active material-uncoated portion 122. In the drawing, an embodiment is illustrated in which the angle at which the dividing line 412 is inclined with respect to the winding direction increases from left to right. Conversely, the angle at which the dividing line 412 is inclined with respect to the winding direction may decrease from left to right in the drawing.

According to the secondary battery having such a structure, poor contact between the active material-uncoated portion of the electrode assembly and the current collector may be prevented. In addition, poor welding between the active material-uncoated portion of the electrode assembly and the current collector may be prevented.

Some embodiments of the present disclosure can provide a secondary battery.

In addition, some embodiments of the present disclosure can provide a secondary battery in which poor contact between an active material-uncoated portion of an electrode assembly and a current collector is prevented.

In addition, some embodiments of the present disclosure can provide a secondary battery in which poor welding between an active material-uncoated portion of an electrode assembly and a current collector is prevented.

The above description is merely an example of applying the principles of the present disclosure, and other configurations may be further comprised without departing from the scope of the present disclosure.

The above description is merely an example applying the principle of the present disclosure, and other configurations may be further comprised without departing from the scope of the present disclosure. While the embodiments of the present disclosure have been described above, it will be apparent to those skilled in the art that the present disclosure may be variously modified or changed by adding, altering, or deleting components within the scope of the technical idea of the present disclosure described in the claims, and this is also comprised in the scope of the present disclosure.

What is claimed is:

1. A secondary battery comprising an electrode assembly in which a first electrode, a second electrode, and a separator are wound, each of the first electrode and the second electrode comprises an active material-coated portion on which an active material is coated and an active material-uncoated portion on which the active material is not coated, and the active material-uncoated portion comprises a plurality of flaps arranged in a winding direction and bent,
wherein the active material-uncoated portion is provided with a cutting line that cuts a part of a portion in which each flap is bent.

2. The secondary battery of claim 1, wherein the active material-uncoated portion of the first electrode is provided at an upper end of the first electrode and the active material-uncoated portion of the second electrode is provided at a lower end of the second electrode.

3. The secondary battery of claim 1, wherein the bent flap forms a welding surface to which a current collector is welded.

4. The secondary battery of claim 1, wherein the cutting line is provided parallel to the winding direction.

5. The secondary battery of claim 1, wherein the cutting line is provided at one end of a bent portion of each flap.

6. The secondary battery of claim 1, wherein the cutting line is provided at both ends of a bent portion of each flap.

7. The secondary battery of claim 1, wherein each flap is provided by a dividing line that is spaced apart from each other in the winding direction and divides the active material-uncoated portion.

8. The secondary battery of claim 7, wherein the dividing line is provided perpendicular to the winding direction.

9. The secondary battery of claim 7, wherein the dividing line is provided inclined with respect to the winding direction.

10. The secondary battery of claim 7, wherein an angle at which the dividing line is inclined with respect to the winding direction gradually increases or decreases in the winding direction.

11. The secondary battery of claim 7, wherein the cutting line is connected to an inner end portion of the dividing line.

12. The secondary battery of claim 11, wherein the cutting line extends from the inner end portion of the dividing line to one side in the winding direction.

13. The secondary battery of claim 11, wherein the cutting line extends from the inner end portion of the dividing line to both sides in the winding direction.

14. The secondary battery of claim 1, comprising a case accommodating the electrode assembly,
wherein the case is provided in a cylindrical shape having a predetermined diameter and height.
